(19) United States
(12) Patent Application Publication
(10) Pub. No.: US 2026/0005345 A1
(43) Pub. Date: Jan. 1, 2026

(54) BATTERY CELL, MANUFACTURING METHOD THEREOF AND BATTERY MODULE

(71) Applicant: SK On Co., Ltd., Seoul (KR)

(72) Inventors: Dong Hyee LEE, Daejeon (KR); Seong Che PARK, Daejeon (KR); Seung Ho KWAK, Daejeon (KR); Byeong Jun PAK, Daejeon (KR); Hoemin CHEONG, Daejeon (KR); Seung Hoon JU, Daejeon (KR)

(21) Appl. No.: 19/190,820

(22) Filed: Apr. 28, 2025

(30) Foreign Application Priority Data
Jun. 28, 2024 (KR) 10-2024-0085036

(51) Int. Cl. H01M 50/152; H01M 50/107; H01M 50/169; H01M 50/559

(52) U.S. Cl. CPC H01M 50/152; H01M 50/107; H01M 50/169; H01M 50/559

(57) ABSTRACT

The present disclosure provides battery cell including: an electrode assembly; a cell case in which an accommodation space for accommodating the electrode assembly is formed and one side thereof is open and; a cap plate covering an open portion of the cell case and coupled to the cell case; and a magnetic member providing magnetic force to the cap plate so that the cap plate may maintain an aligned position with respect to the cell case, wherein the magnetic member is disposed on at least one of the electrode assembly, the cell case or the cap plate.

### CROSS-REFERENCE TO RELATED APPLICATION(S)

This patent document claims the priority and benefits of Korean Patent Application No. 10-2024-0085036 filed on Jun. 28, 2024, the disclosure of which is incorporated herein by reference in its entirety.

### TECHNICAL FIELD

The present disclosure relates to a battery cell, a manufacturing method thereof and a battery module.

### BACKGROUND

Secondary battery cells, unlike primary batteries, are convenient in that they may be charged with or discharged of electricity therein or therefrom, and are thus receiving much attention as power sources for various mobile devices, electric vehicles, and energy storage devices.

Secondary battery cells may be manufactured as pouch-type cells or can-type cells. Pouch-type cells have a structure in which the electrode assembly is accommodated inside a flexible cell case (pouch). Can-type cells have a structure in which the electrode assembly is accommodated inside a rigid cell case (can), and may be classified into a cylindrical cell, a square cell, and a coin-type cell.

### SUMMARY

A secondary battery cell may include an electrode assembly, a cell case accommodating the electrode assembly, and a cap plate covering the cell case. The electrode assembly may be inserted into the inside of the cell case, and the cap plate may be coupled to the cell case in a state in which the accommodation space is covered by the cap plate. When the cap plate is not aligned with respect to the cell case in which the accommodation space of the cell case is covered by the cap plate, defects may occur in the battery cell. For example, when vibrations occur in a state in which the cap plate is accommodated in the cell case, the cap plate may easily deviate from an aligned position. Additionally, in order to increase the productivity of the battery cell, when the process velocity is increased, misalignment of the cap plate may easily occur, and thus a defect rate of the battery cell may increase.

According to an aspect of the present disclosures, a battery cell that may prevent or reduce misalignment of the cap plate, a manufacturing method thereof, and a battery module may be provided.

According to an aspect of the present disclosure, a battery cell that may reduce a defect rate of a battery cell, a method of manufacturing the same, and a battery module may be provided.

According to an aspect of the present disclosure, a battery cell that may increase coupling force between a cap plate and a cell case and may thus increase sealing force between the cell case and the cap plate, a method of manufacturing the same, and a battery module may be provided.

The battery cell and/or the battery module of the present disclosure may be widely applied to electric vehicles, battery charging stations, and devices in green technology fields such as solar power generation and wind power generation using other batteries. In addition, the battery cell and/or the battery module of the present disclosure may be used in eco-friendly electric vehicles, hybrid vehicles, etc. to prevent climate change by suppressing air pollution and greenhouse gas emissions.

A battery cell according to the present disclosure may include: an electrode assembly; a cell case in which an accommodation space for accommodating the electrode assembly is formed and one side thereof is open and; a cap plate covering an open portion of the cell case and coupled to the cell case; and a magnetic member providing magnetic force to the cap plate so that the cap plate may maintain an aligned position with respect to the cell case, and the magnetic member may be disposed on at least one of the electrode assembly, the cell case or the cap plate.

According to an embodiment, the electrode assembly may include a body in which electrodes and separators are arranged to form layers, a first electrode tab disposed on a first side of the body and having a first polarity, a second electrode tab disposed on a second side of the body and having a second polarity, and a core disposed in a center of the body, and the magnetic member may include a first member disposed on the core so as to provide magnetic force to the cap plate.

According to an embodiment, the magnetic member may further include a second member disposed on the cap plate at a position corresponding to the first member, and at least one of the first member or the second member may include a magnetic body.

According to an embodiment, the cell case may include an upper plate covering an upper portion of the electrode assembly, and a tube covering a side surface of the electrode assembly, and the magnetic member may include a first member disposed on a lower end of the tube so as to face a circumferential surface of the cap plate.

According to an embodiment, the tube may have a shape extending in a first direction, the tube may include a beading portion recessed in a second direction toward a center of the cell case, and the first member may be disposed further outward in the first direction than the beading portion.

According to an embodiment, the first member may be comprised of a plurality of members disposed on the lower end of the tube.

According to an embodiment, the cell case may include an upper plate covering the upper portion of the electrode assembly and a tube covering the side surface of the electrode assembly, and the tube may include a beading portion recessed toward a center of the cell case, and a crimping portion covering the cap plate with a lower end of the tube.

According to an embodiment, the cell case may include an upper plate covering an upper portion of the electrode assembly and a tube covering a side surface of the electrode assembly, the tube may include a bent portion formed by bending a lower end of the tube toward an inside of the cell case, and the magnetic member may include a first member disposed on the bent portion so as to face an inner surface of the cap plate.

According to an embodiment, the magnetic member may further include a second member disposed on the cap plate at a position corresponding to the first member, and at least one of the first member or the second member may include a magnetic body.

According to an embodiment, the tube may further include a weld portion formed by welding the lower end of the tube and the cap plate.

According to an embodiment, the cell case may include an upper plate covering an upper portion of the electrode assembly, and a tube covering a side surface of the electrode assembly, the tube may include a circular cross-section, and the upper plate and the tube may be formed integrally.

According to an embodiment, the battery cell may further include an electrode terminal installed on the upper plate and electrically connected to a first electrode tab of the electrode assembly, and the electrode terminal may be coupled to a through-hole of the upper plate and has a rivet shape.

A method of manufacturing a battery cell may include a preparation operation of preparing an electrode assembly, a cell case in which an accommodation space for accommodating the electrode assembly is formed and one side thereof is open, a cap plate covering an open portion of the cell case, and a magnetic member providing magnetic force to the cap plate; an electrode assembly disposition operation of disposing the electrode assembly in the accommodation space of the cell case; a cap plate disposition operation of covering the open portion of the cell case with the cap plate; and a cap plate fixing operation of coupling the cell case and the cap plate, and the magnetic member may be disposed on at least one of the electrode assembly, the cell case or the cap plate, in the cap plate disposition operation, the cap plate may maintain the aligned position with respect to the cell case through the magnetic member, and the cap plate fixing operation may be performed in a state in which the cap plate maintains the aligned position.

According to an embodiment, in the cap plate disposition operation, the cap plate may maintain the aligned position with respect to the cell case through the magnetic member disposed on a core of the electrode assembly.

According to an embodiment, the cell case may include an upper plate covering an upper portion of the electrode assembly and a tube covering a side surface of the electrode assembly, and in the cap plate disposition operation, the cap plate maintains the aligned position with respect to the cell case through the magnetic member disposed in a lower end of the tube.

According to an embodiment, the cell case may include an upper plate covering an upper portion of the electrode assembly and a tube covering a side surface of the electrode assembly, and the cap plate disposition operation may include a process of forming a beading portion recessed toward a center of the cell case in a lower end of the tube, and a process of disposing the cap plate above the beading portion.

According to an embodiment, the cap plate fixing operation may include a process of forming a crimping portion covering the cap plate with the lower end of the tube.

According to an embodiment, the cell case may include an upper plate covering an upper portion of the electrode assembly and a tube covering a side surface of the electrode assembly, and the cap plate disposing operation may include a process of forming a bent portion bent toward an inside of the cell case in a lower end of the tube, and a process in which the cap plate maintains the aligned position with respect to the cell case through the magnetic member disposed in the bent portion so as to face an inner surface of the cap plate.

According to an embodiment, the cap plate fixing operation may include a process of welding the cap plate to the lower end of the tube.

A battery module according to the present disclosure may include: a plurality of battery cells; and a module housing accommodating the plurality of battery cells, and at least one of the plurality of battery cells may include: an electrode assembly; a cell case in which an accommodation space for accommodating the electrode assembly is formed and one side thereof is open; a cap plate covering an open portion of the cell case and coupled to the cell case; and a magnetic member providing magnetic force to the cap plate so that the cap plate may maintain an aligned position, and the magnetic member may be disposed on at least one of the electrode assembly, the cell case or the cap plate.

According to an embodiment of the present disclosure, misalignment of the cap plate may be prevented or reduced.

According to an embodiment of the present disclosure, a defect rate of a battery cell may be reduced.

According to an embodiment of the present disclosure, coupling force between the cap plate and the cell case may be increased, and thus sealing force between the cell case and the cap plate may be increased.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is an exploded perspective view of a battery cell according to an embodiment.

FIGS. 3A to 3C are cross-sectional views sequentially illustrating a manufacturing process of the battery cell illustrated in FIG. 2, and illustrate cross-sections taken along line I-I′ of FIG. 2.

FIGS. 4A to 4C are cross-sectional views sequentially illustrating a manufacturing process of a battery cell according to another embodiment.

FIGS. 5A to 5C are cross-sectional views sequentially illustrating a manufacturing process of a battery cell according to another embodiment.

FIG. 6 is an exploded perspective view of a battery cell according to another embodiment.

FIGS. 7A to 7C are cross-sectional views sequentially illustrating a manufacturing process of the battery cell illustrated in FIG. 6, and illustrate cross-sections taken along line II-II′ of FIG. 6.

FIGS. 8A to 8C are cross-sectional views sequentially illustrating a manufacturing process of a battery cell according to another embodiment.

FIG. 9 is a flow chart illustrating a method of manufacturing a battery cell according to an embodiment.

FIG. 10 is a perspective view of a battery module according to an embodiment.

### DETAILED DESCRIPTION

The same reference numeral or symbol written in each accompanying drawing of the specification refers to parts or components that perform substantially the same function. The present inventive concept is described using the same reference numeral or symbol even in different exemplary embodiments for easy description and appreciation. In this aspect, although all components having the same reference numeral are illustrated in a plurality of drawings, the plurality of drawings do not necessarily refer to a single exemplary embodiment. In this specification, the singular also includes the plural unless specifically stated otherwise in the phrase. It will be further understood that the terms “comprises,” “comprising,” “includes” and/or “including”, when used herein, specify the presence of stated features, integers, steps, operations, elements, components and/or combinations thereof, but do not preclude the presence or addition of one or more other features, integers, steps, operations, elements, components, and/or groups thereof.

In addition, it should be noted in advance that the expressions such as “above,” “upper,” “below”, “beneath,” “lower,” “side,” “front,” and “rear” are based on the direction illustrated in the drawings, and may be expressed differently if the direction of the object is changed.

In addition, in the present specification and claims, terms including ordinal numbers such as “first” and “second” may be used to distinguish between components. These ordinal numbers are used to distinguish the same or similar components from each other, and the meaning of the terms should not be construed as limited by the use of these ordinal numbers. For example, the components combined with these ordinal numbers should not be construed as limiting the order of use or arrangement of the components. If necessary, the ordinal numbers may be used interchangeably.

Hereinafter, the present disclosure will be described in detail with reference to the attached drawings. However, these are merely examples and the present disclosure is not limited to the specific embodiments described by way of example.

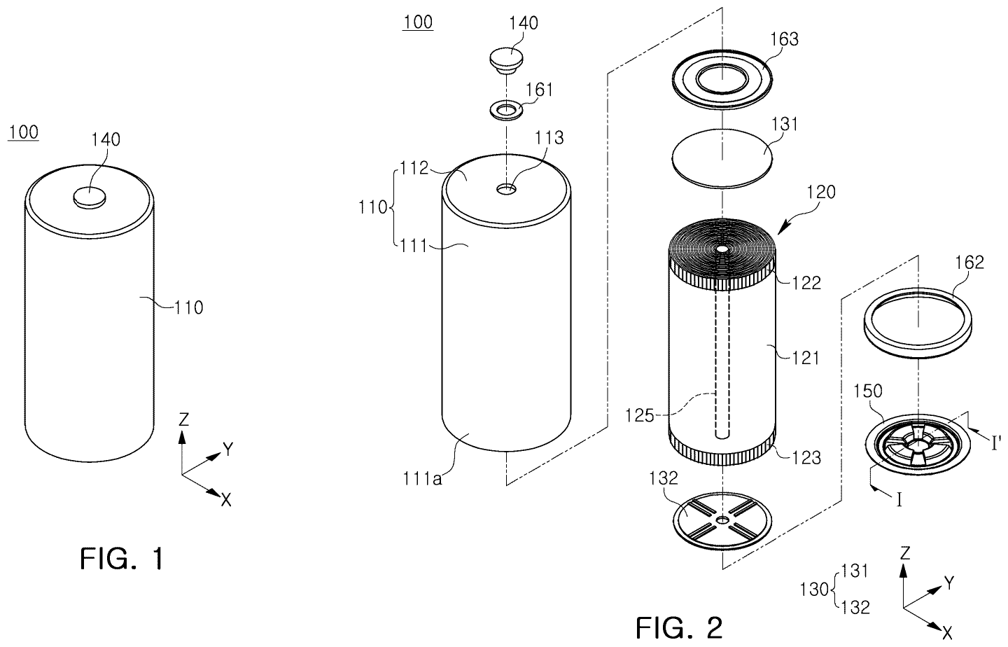

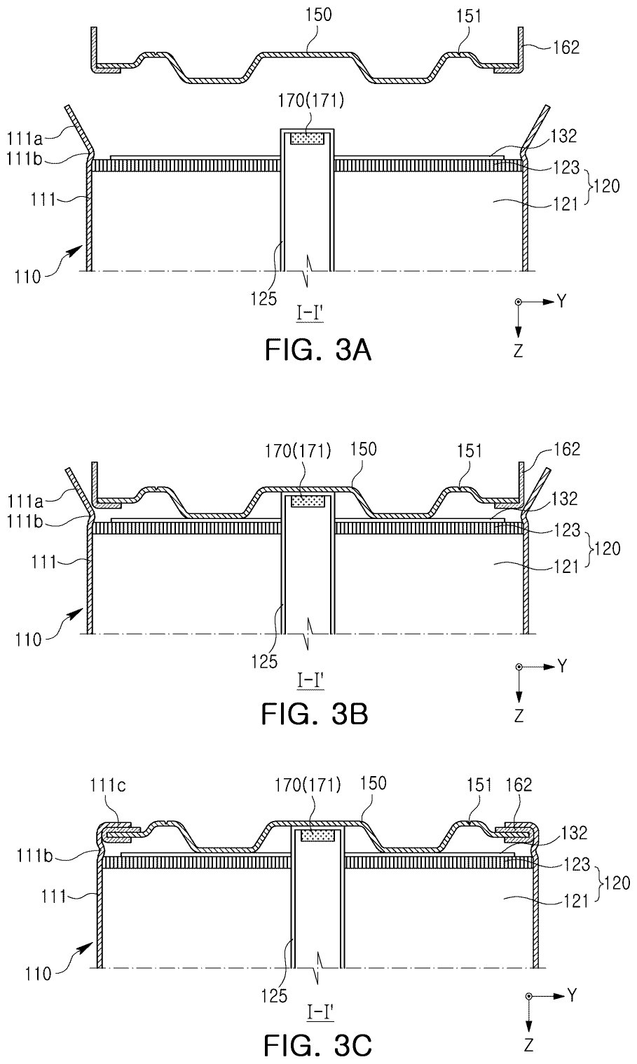

FIG. 1 is a perspective view of a battery cell 100 according to an embodiment. FIG. 2 is an exploded perspective view of a battery cell 100 according to an embodiment. FIGS. 3A to 3C are cross-sectional views sequentially illustrating a manufacturing process of the battery cell 100 illustrated in FIG. 2, and illustrate cross-sections taken along line I-I′ of FIG. 2. FIGS. 3A to 3C illustrate that the battery cell 100 illustrated in FIGS. 1 and 2 is inverted upside down. That is, FIGS. 3A to 3C illustrate a shape in which a cap plate 150 is coupled to a lower portion of a cell case 110.

In the present disclosure, an upper side, an upper portion, a lower side and a lower portion are named based on FIGS. 1 and 2, and FIGS. 3A to 5C are illustrated such that a lower portion of the cell case 110 are oriented upwardly on the drawing to describe the assembly process of the cap plate 150.

Referring to FIGS. 1 to 3C, a battery cell 100 according to an embodiment may include an electrode assembly 120, a cell case 110 in which an accommodation space for accommodating the electrode assembly 120 and one side thereof is open, a cap plate 150 covering an open portion of the cell case 110 and coupled to the cell case 110, and a magnetic member 170 providing magnetic force to the cap plate 150 so that the cap plate 150 may maintain the aligned position with respect to the cell case 110. The magnetic member 170 may be disposed on at least one of the electrode assembly 120, the cell case 110 or the cap plate 150.

A battery cell 100 according to an embodiment may further include an electrode terminal 140 disposed in the cell case 110, a first current collector 131 electrically connected to a first electrode tab 122 of an electrode assembly 120, and a second current collector 132 electrically connected to a second electrode tab 123 of an electrode assembly 120.

The battery cell 100 according to the present disclosure may be configured as a cylindrical cell, but is not limited thereto. In the present disclosure, a cylindrical cell will be exemplified to describe a battery cell 100 according to an embodiment.

In the cell case 110, the accommodation space for accommodating the electrode assembly 120 may be formed and one side thereof may have an open shape. Based on FIGS. 1 and 2, the cell case 110 may have an open shape in a lower end thereof.

The cell case 110 may include an upper plate 112 covering an upper portion of the electrode assembly 120, and a tube 111 covering a side surface of the electrode assembly 120. The accommodation space may be formed by the tube 111 of the cell case 110 and the upper plate 112.

The tube 111 may have a shape extending in the first direction (Z-direction). The tube 111 may have a circular cross-section. The tube 111 may have a hollow cylinder shape having a circular cross-section, but is not limited thereto.

The upper plate 112 may have a plate shape covering an upper side of the accommodation space. The upper plate 112 may have an overall flat shape.

Thicknesses of the upper plate 112 and the tube 111 in the cell case 110 may be variously changed. For example, the upper plate 112 and the tube 111 may have the same thickness, and on the contrary, the thickness of the upper plate 112 may have a greater value than the thickness of the tube 111. The cell case 110 may include a metal material such as aluminum or an aluminum alloy, but the material of the cell case 110 may be changed in various ways.

The upper plate 112 and the tube 111 may be formed integrally. For example, the cell case 110 may be manufactured in a shape in which the tube 111 and the upper plate 112 are formed integrally by deep drawing a metal sheet. When the cell case 110 is formed integrally, since a process of coupling the tube 111 and the upper plate 112 is not required, the manufacturing of the cell case 110 and/or the battery cell 100 may be easy and workability may be improved.

However, the cell case 110 of the present disclosure is not limited to a configuration in which the tube 111 and the upper plate 112 are formed integrally, and it may also be possible for the tube 111 and the upper plate 112 to be manufactured separately and then coupled or bonded to each other by welding or the like.

A through-hole 113 may be formed in the upper plate 112 of the cell case 110. The through-hole 113 may be provided for being coupling to the electrode terminal 140. The cell case 110 may have a circular cross-sectional shape, and the through-hole 113 may be formed in a center of the upper plate 112. In this case, the electrode terminal 140 coupled to the through-hole 113 may be disposed at the center of the upper plate 112.

The tube 111 may include a beading portion 111b recessed toward a center of the cell case 110, and a crimping portion 111c covering the cap plate 150 with a lower end 111a of the tube 111. The beading portion 111b may prevent the electrode assembly 120 from being dislodged outward in the first direction (Z-direction). The cap plate 150 may be disposed on the beading portion 111b. The crimping portion 111c may fix the cap plate 150. The crimping portion 111c may be formed by pressing the lower end 111a of the tube 111 toward the center of the cell case 110, and may have a rolled shape in a curved shape.

The electrode assembly 120 may be disposed in the accommodation space of the cell case 110. The electrode assembly 120 may include a cathode, an anode and a separator. Each of the cathode and the anode may include a current collecting foil (or a metal foil) and a composite layer applied to at least one surface of the current collecting foil. The composite layer may include an active material. The separator may be interposed between the cathode and the anode to electrically insulate the cathode and the anode. The cathode, the anode and the separator may be repeatedly disposed to form the electrode assembly 120. As an example, the electrode assembly 120 may have a winding shape in which the cathode, the separator and the anode are wound in a stacked state. However, the electrode assembly 120 is not limited to the winding structure. For example, the electrode assembly 120 may have a stacking shape, a zigzag-folding shape, or a stack-folding shape.

The electrode assembly 120 may include a first electrode and a second electrode having different polarities. As an example, the first electrode may be provided as a cathode and the second electrode may be provided as an anode, or vice versa.

The electrode assembly 120 may include a body 121 in which electrodes and separators are arranged in layers, a first electrode tab 122 disposed on a first side of the body 121 and having a first polarity, a second electrode tab 123 disposed on a second side of the body 121 and having a second polarity, and a core 125 disposed in a center of the body 121. In some embodiments, the core 125 may not be disposed in the electrode assembly 120.

The first electrode tab 122 may extend from the first electrode, and the second electrode tab 123 may extend from the second electrode. As an example, the first electrode tab 122 may be a cathode tab, and the second electrode tab 123 may be an anode tab, or vice versa. The first electrode tab 122 and the second electrode tab 123 may have a form in which the first electrode tab 122 and the second electrode tab 123 overlap each other in a certain shape or are laid down.

The first electrode tab 122 may be electrically connected to the first current collector 131. As an example, the first electrode tab 122 and the first current collector 131 may be electrically connected to each other by welding or the like. The second electrode tab 123 may be electrically connected to at least one of the second current collector 132, the cap plate 150 or the tube 111 of the cell case 110. As an example, the second electrode tab 123 and the second current collector 132 may be coupled to each other by welding, such as ultrasonic welding or laser welding. However, a method of coupling the second electrode tab 123 and the second current collector 132 is not limited thereto.

The electrode terminal 140 may be installed on the upper plate 112 and may be electrically connected to the first electrode tab 122 of the electrode assembly 120. The electrode terminal 140 may be electrically connected to the first electrode tab 122 through the first current collector 131.

At least a portion of the electrode terminal 140 may be exposed to the outside of the cell case 110. When the first collector 131 is connected to the cathode, the electrode terminal 140 may correspond to a cathode terminal, or vice versa.

The electrode terminal 140 is connected to the through-hole 113 of the upper plate 112 and may have a rivet shape. The electrode terminal 140 may be coupled to the through-hole 113 of the cell case 110 by a rivet. The electrode terminal 140 may be connected to the upper plate 112 by a rivet process in a state of being inserted into the through-hole 113 of the upper plate 112.

The electrode terminal 140 may be inserted into the through-hole 113 from the outside of the upper plate 112. Since an outer diameter of the electrode terminal 140 is greater than a diameter of the through-hole 113, an upper portion of the electrode terminal 140 may be disposed on the outside of the upper plate 112. The lower portion of the electrode terminal 140 may be deformed by a riveting process, and thus the electrode terminal 140 may be fixed to the upper plate 112.

The battery cell 100 according to an embodiment may further include a first gasket 161 disposed between the electrode terminal 140 and the through-hole 113 and having electrical insulation.

The first gasket 161 may be disposed between the electrode terminal 140 and the upper plate 112 to insulate between the electrode terminal 140 and the upper plate 112. The first gasket 161 may include an electrically insulating material. The first gasket 161 may serve as a sealing member sealing a space between the electrode terminal 140 and the upper plate 112.

When the riveting process is performed with the first gasket 161 disposed on the outside of the electrode terminal 140, the first gasket 161 may be disposed between the electrode terminal 140 and the upper plate 112. The first gasket 161 may seal and/or insulate the space between the electrode terminal 140 and the upper plate 112.

The first current collector 131 may electrically connect the electrode terminal 140 and the electrode assembly 120.

The first current collector 131 may be electrically connected to the first electrode tab 122 of the electrode assembly 120 from a lower side, and may be electrically connected to the electrode terminal 140 from an upper side. As an example, the first current collector 131 and the first electrode tab 122 may be coupled to each other by welding such as ultrasonic welding, laser welding, or resistance welding, but the coupling method is not limited thereto. The first current collector 131 and the electrode terminal 140 may be coupled to each other by welding such as laser welding.

In order to electrically insulate the first current collector 131 and the cell case 110, an insulating member 163 having electrically insulation may be disposed between the first current collector 131 and the cell case 110. As an example, the insulating member 163 may be disposed between the first current collector 132 and the upper plate 112. The shape or arrangement of the insulating member 163 may be variously changed.

The cap plate 150 may cover the open portion of the cell case 110 and may be coupled to the cell case 110. The cap plate 150 may cover a bottom side of the accommodation space of the cell case 110. The cap plate 150 may be crimped or welded to the cell case 110.

The cap plate 150 may cover the accommodation space on an opposite side to the electrode terminal 140. The cap plate 150 may be coupled to the tube 111 of the cell case 110 by crimping, welding, or the like.

As an example, after a beading process is performed on an open end 111a of the tube 111 of the cell case 110 to form a beading portion 111b, in a state in which the cap plate 150 is disposed on the beading portion 111b, a crimping process may be performed on the end 111a of the tube 111 and the cap plate 150 to form a crimping portion 111c.

A vent 151 for discharging gas to the outside may be formed in the cap plate 150 when internal pressure of the cell case 110 increases. Since the vent 151 is formed in a position opposite to the upper plate 112 on which the electrode terminal 140 is disposed, it may be possible to prevent gas discharged from the cell case 110 from damaging the bus bar connected to the electrode terminal 140.

A second gasket 162 for sealing may be disposed between the cap plate 150 and the tube 111 of the cell case 110. The second gasket 162 may serve as a sealing member sealing a space between the cap plate 150 and the tube 111.

The battery cell 100 according to an embodiment may further include a second current collector 132 electrically connected to the second electrode tab 123 of the electrode assembly 120.

Referring to FIG. 2, an upper surface of the second current collector 132 may be configured to be bonded or be in contact with the second electrode tab 123 so as to be electrically connected to the second electrode tab 123. Welding may be used to bond the second current collector 132 and the second electrode tab 123. For example, the second current collector 132 and the second electrode tab 123 may be bonded by ultrasonic welding, laser welding, resistance welding, or the like. Alternatively, the second current collector 132 may be electrically connected to the second electrode tab 123 in a state in which the second current collector 132 and the second electrode tab 123 are not bonded and are in contact with each other.

The second current collector 132 may be electrically connected to at least one of the cap plate 150 or the tube 111 of the cell case 110. The cap plate 150 may have a second polarity. As an example, when the second electrode tab 123 is an anode tab, the cap plate 150 may be charged to an anode. An object electrically connected to the second current collector 132 may be variously changed depending on the design specifications of the battery cell 100. Meanwhile, it may also be possible to have a configuration in which the second current collector 132 is not disposed and the second electrode tab 123 is directly electrically connected to the cap plate 150.

The magnetic member 170 may provide magnetic force to the cap plate 150 so that the cap plate 150 may maintain an aligned position with respect to the cell case 110. The magnetic member 170 may be disposed on (or in) at least one of the electrode assembly 120, the cell case 110 or the cap plate 150.

Referring to FIGS. 3A to 3C, the magnetic member 170 may be disposed in the electrode assembly 120. The electrode assembly 120 may include a body 121, a first electrode tab 122, a second electrode tab 123 and a core 125. The core 125 may be disposed in the center of the body 121 and may function as a center member when winding the electrode and the separator. The magnetic member 170 may be disposed in the core 125 of the electrode assembly 120.

The magnetic member 170 may include a first member 171 disposed on the core 125 so as to provide magnetic force to the cap plate 150. The first member 171 may be disposed in a closed end 111a of the core 125. The first member 171 may be attached to an inner surface of the end 111a of the core 125.

The first member 171 may include a magnetic material. The first member 171 may provide magnetic force to the cap plate 150 so that the cap plate 150 may maintain an aligned position with respect to the cell case 110. The cap plate 150 may include a metal material coupled to a magnetic body.

The first member 171 may have magnetic force sufficient to maintain a state in which the cap plate 150 is in contact. For example, the first member 171 may include a ferromagnetic body. As the ferromagnetic body, a ferrite magnet, a neodymium alloy, or the like, may be used. In addition, the magnetic body may be variously modified, such as other types of metal magnets, metal oxide magnets, rubber magnets, or the like.

Referring to FIG. 3A, after the electrode assembly 120 is disposed in the accommodation space of the cell case 110, a beading portion 111b recessed in a second direction (Y-direction) toward the center of the cell case 110 may be formed in the lower end 111a of the tube 111. The second direction (Y-direction) may be a radial direction of the cell case 110.

Referring to FIG. 3B, the open portion of the cell case 110 may be covered by the cap plate 150. The cap plate 150 may be disposed on the beading portion 111b. When the cap plate 150 is disposed on the electrode assembly 120, the first member 171 of the magnetic member 170 may provide the magnetic force to the cap plate 150. The cap plate 150 may maintain the aligned position with respect to the cell case 110 by the magnetic member 170. Accordingly, even when the cell case 110 moves or vibrations occur in the cell case 110 for the purpose of proceeding with the manufacturing process, the magnetic member 170 may maintain the cap plate 150 and the cell case 110 in an aligned state.

The second gasket 162 may be disposed on a circumferential surface of the cap plate 150 to seal a space between the cap plate 150 and the cell case 110.

Referring to FIG. 3C, in order to secure the cap plate 150 to the tube 111 of the cell case 110, a crimping portion 111c covering the cap plate 150 with the lower end 111a of the tube 111 may be formed. The crimping portion 111c may be formed by pressing the lower end 111a toward the center of the cell case 110, and may have a rolled shape in a curved shape.

The second gasket 162 disposed on the circumferential surface of the cap plate 150 may be crimped together with the lower end 111a of the tube 111. The second gasket 162 may seal the space between the cap plate 150 and the tube 111.

In the case of the conventional art, when the cap plate and the cell case are transferred to a next process in a state in which the cap plate is disposed on the cell case, misalignment of the cap plate may occur due to left-right shaking, up-down shaking, vibration, and the like, and thus defects may occur in subsequent processes.

According to an embodiment, since the cap plate 150 may maintain a stable state by the magnetic member 170, the problems such as left-right shaking, up-down shaking, vibration, and a the like, may be resolved or improved. Accordingly, in subsequent processes such as a process of fixing the cap plate 150 to the tube 111 of the cell case 110, the cap plate 150 may be maintained in the aligned state with respect to the cell case 110 by the magnetic force of the magnetic member 170. Accordingly, the misalignment of the cap plate 150 may be prevented or reduced. In addition, a defect rate of the battery cell 100 may be reduced during a fixing process of the cap plate 150.

Accordingly, according to an embodiment, since the cap plate 150 may be maintained in the aligned state by the magnetic member 170, even when the manufacturing process of the battery cell is performed at a high speed (for example, or more per minute), the occurrence of the defect rate may be reduced, and thus the productivity of the battery cell may be improved.

The magnetic member 170 provides magnetic force to maintain a state in which the cap plate 150 is coupled to the cell case 110, so that the coupling force between the cap plate 150 and the cell case 110 may be increased, and accordingly, sealing force between the cell case 110 and the cap plate 150 may be increased. For example, even if a fine crack occurs in a bonded portion between the cell case 110 and the cap plate 150, the magnetic force of the magnetic member 170 may prevent or slow down the growth of the fine crack, and thus, an electrolyte may be prevented from leaking to the outside.

Meanwhile, in the case of the comparative example in which the cap plate is fixed with an adhesive, since foreign substances due to the adhesive may remain inside the cell case, foreign substance management may be required, but according to an embodiment, since no foreign substances occur, the quality of the battery cell may be improved.

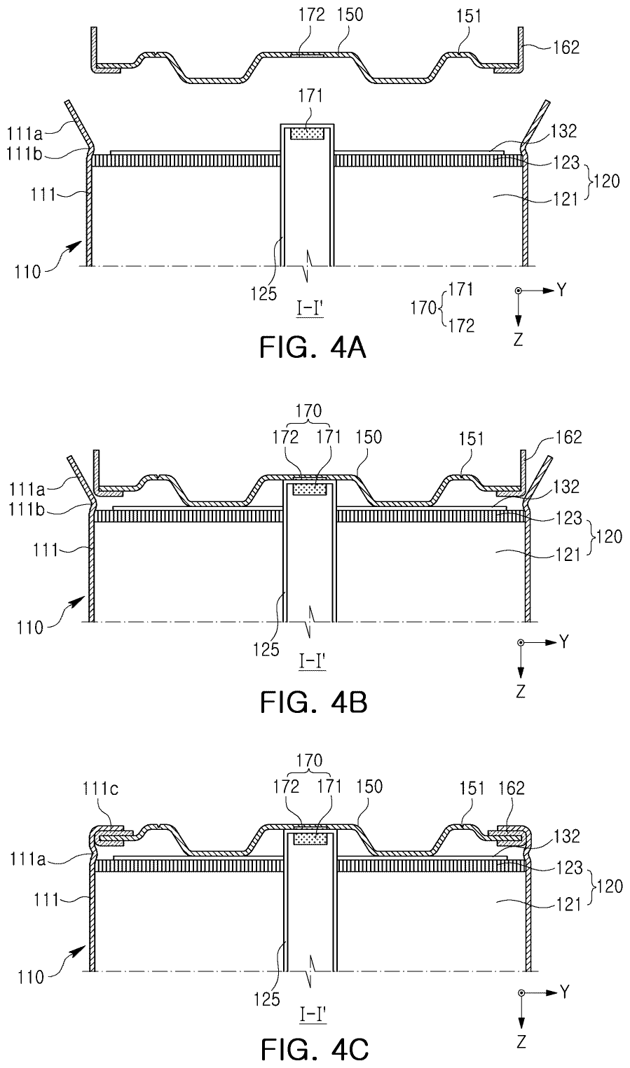

FIGS. 4A to 4C are cross-sectional views sequentially illustrating a manufacturing process of a battery cell 100 according to another embodiment.

As compared to FIGS. 3A to 3C, embodiments illustrated in FIGS. 4A to 4C differ from those of FIGS. 3A to 3C only in an arrangement structure of the magnetic member 170. The description of FIGS. 1 to 3C may also be applied to FIGS. 4A to 4C except for the difference.

Referring to FIGS. 4A to 4C, the magnetic member 170 may further include a second member 172 disposed on the cap plate 150 at a position corresponding to the first member 171. That is, the magnetic member 170 may include a first member 171 and a second member 172.

The first member 171 may be disposed in the core 125 of the electrode assembly 120 so as to face the cap plate 150, and the second member 172 may be disposed on a portion of the cap plate 150 facing the core 125. The second member 172 may be attached to the cap plate 150. A groove for installing the second member 172 may be formed in the cap plate 150, and the second member 172 may be attached in a state of being fitted into the groove of the cap plate 150. The second member 172 may be disposed on an inner surface of the cap plate 150 facing the electrode assembly 120, but the present disclosure is not limited thereto.

At least one of the first member 171 or the second member 172 may include a magnetic material.

When both the first member 171 and the second member 172 include the magnetic material, the first member 171 and the second member 172 may be disposed so that different polarities (N pole or S pole) thereof face each other so that attractive force acts therebetween. Alternatively, one of the first member 171 and the second member 172 may include the magnetic material, and the other thereof may include a metal material that is couplable to the magnetic material by the magnetic force of the magnetic material.

When the cap plate 150 is formed of a metal material that does not react to or is not sensitive to magnetic force, the cap plate 150 may be aligned with respect to the cell case 110 by the magnetic force between the first member 171 and the second member 172.

Referring to FIG. 4A, after the electrode assembly 120 is disposed in the accommodation space of the cell case 110, a beading portion 111b recessed in a direction oriented toward the center of the cell case 110 may be formed on the lower end 111a of the tube 111.

Referring to FIG. 4B, the cap plate 150 may be disposed on the beading portion 111b. When the cap plate 150 is disposed on the electrode assembly 120, the cap plate 150 may maintain the aligned position with respect to the cell case 110 by the first member 171 and the second member 172.

Referring to FIG. 4C, in order to fix the cap plate 150 to the tube 111 of the cell case 110, a crimping portion 111c covering the cap plate 150 with the lower end 111a of the tube 111 may be formed.

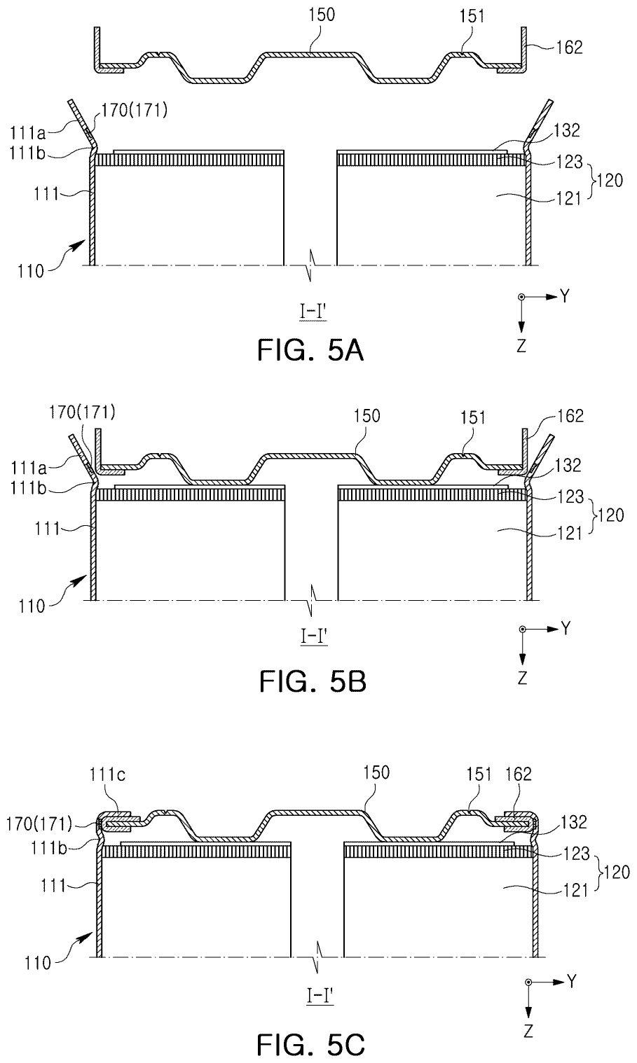

FIGS. 5A to 5C are cross-sectional views sequentially illustrating a manufacturing process of a battery cell 100 according to another embodiment.

As compared to FIGS. 3A to 3C, embodiments illustrated in FIGS. 5a to 5c differ from those of FIGS. 3A to 3C only in an arrangement position and an arrangement structure of the magnetic member 170. The descriptions of FIGS. 1 to 3c may also be applied to FIGS. 5a to 5c except for the difference.

The cell case 110 may include the upper plate 112 (see FIG. 2) covering the upper portion of the electrode assembly 120 and a tube 111 covering the side surface of the electrode assembly 120. Referring to FIGS. 5A to 5C, the magnetic member 170 may include a first member 171 disposed on the lower end 111a of the tube 111 so as to face the circumferential surface of the cap plate 150.

The first member 171 may be attached to a groove formed in the lower end 111a of the tube 111. The first member 171 may be fixed to an inner surface of the tube 111.

The tube 111 may have a shape extending in the first direction (Z-direction). The tube 111 may include a beading portion 111b recessed in the second direction (Y-direction) oriented toward the center of the cell case 110. The first member 171 may be disposed further outward in the first direction (Z-direction) than the beading portion 111b. Since the first member 171 of the magnetic member 170 is disposed further outward than the beading portion 111b, the first member 171 may face the circumferential surface of the cap plate 150 disposed on the beading portion 111b. When the first member 171 is disposed further outward than the beading portion 111b, the first member 171 may be prevented from being separated from the tube 111 in a process of forming the beading portion 111b in the lower end 111a of the tube 111. However, an installation position of the first member 171 is not limited thereto. For example, if the first member 171 may be stably attached to the tube 111, the first member 171 may also be installed in the beading portion 111b.

The first member 171 may be comprised of a plurality of members disposed on the lower end 111a of the tube 111. That is, the first member 171 may be disposed in plural in a circumferential direction in the lower end 111a of the tube 111. A plurality of first members 171 may be spaced apart from each other by a certain interval in the circumferential direction of the tube 111. When the plurality of first members 171 are disposed, not only may the coupling force between the cap plate 150 and the cell case 110 be increased, but also the cap plate 150 may be prevented from rotating.

When the magnetic member 170 is disposed in the tube 111 of the cell case 110, the cap plate 150 may include a metal material bonded to the magnetic body. When the cap plate 150 is formed of a metal material that does not react to or is not sensitive to magnetic force, the magnetic member 170 may also be disposed on the circumferential surface of the cap plate 150. The magnetic member 170 disposed on the circumferential surface of the cap plate 150 may include a magnetic body or a metal material that is couplable to the magnetic body.

Referring to FIG. 5A, after placing the electrode assembly 120 in the accommodation space of the cell case 110, a beading portion 111b recessed in the direction oriented toward the center of the cell case 110 may be formed in the lower end 111a of the tube 111.

Referring to FIG. 5B, the cap plate 150 may be disposed on the beading portion 111b. When the cap plate 150 is disposed on the electrode assembly 120, the cap plate 150 may maintain the aligned position with respect to the cell case 110 by the magnetic member 170 disposed on the lower end 111a of the cell case 110.

Referring to FIG. 5c, in order to fix the cap plate 150 to the tube 111 of the cell case 110, a crimping portion 111c covering the cap plate 150 with the lower end 111a of the tube 111 may be formed.

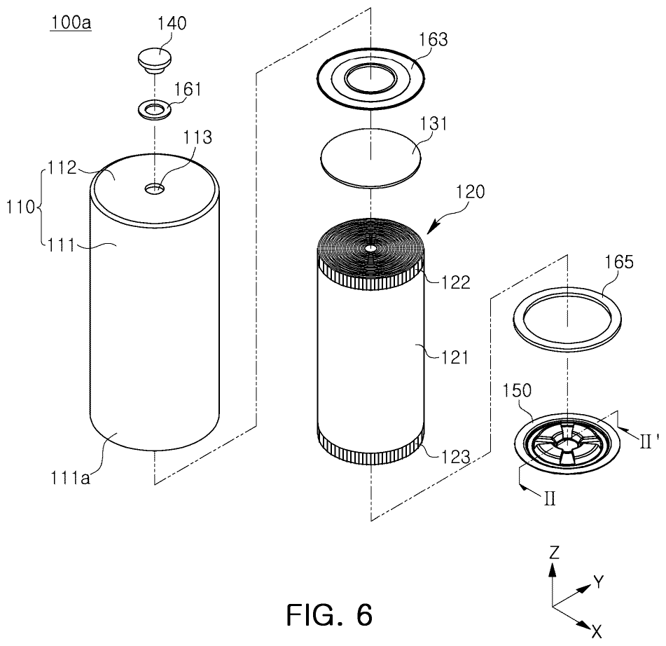

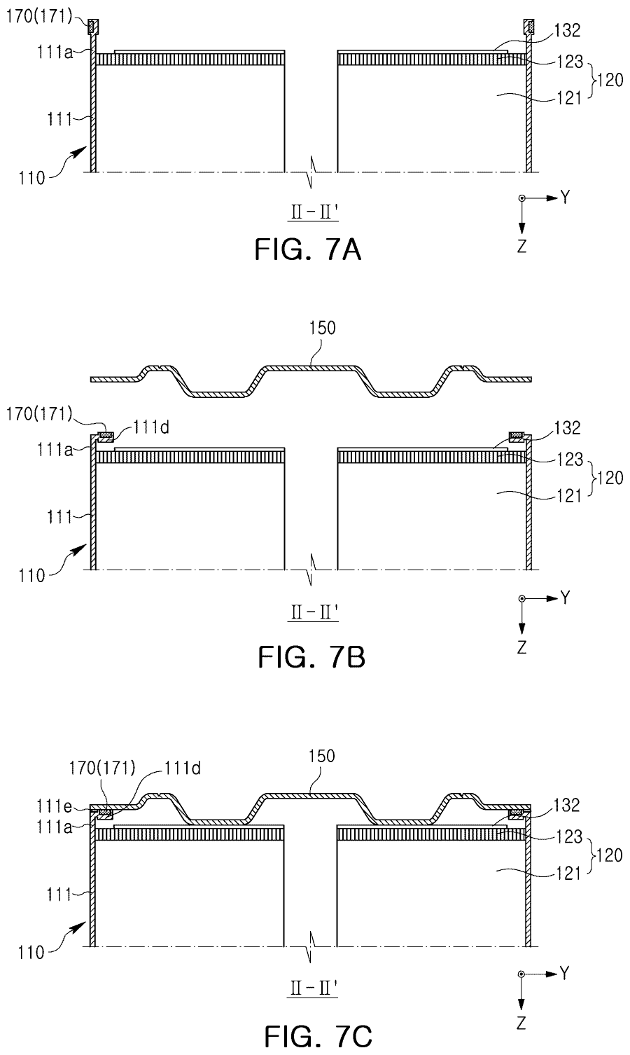

FIG. 6 is an exploded perspective view of a battery cell 100a according to another embodiment. FIGS. 7A to 7C are cross-sectional views sequentially illustrating manufacturing process of the battery cell 100a illustrated in FIG. 6, and illustrate cross-sections taken along line II-II′ of FIG. 6. FIGS. 7A to 7C illustrate that the battery cell 100a illustrated in FIG. 6 is inverted upside down. That is, FIGS. 3A to 3C illustrate a shape in which a cap plate 150 is coupled to the lower portion of a cell case 110.

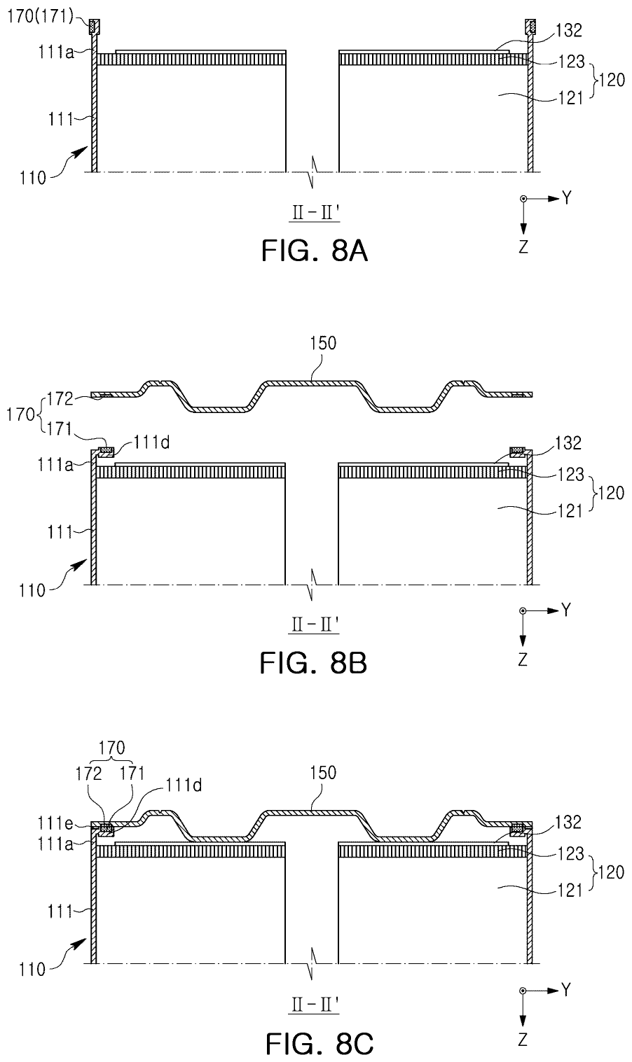

In the present disclosure, an upper side, an upper portion, a lower side and a lower portion are named based on FIG. 6, and FIGS. 7A to 8C illustrate the lower portion of the cell case 110 to face upwardly in the drawing in order to explain the assembly process of the cap plate 150.

As compared to the battery cell 100 illustrated in FIGS. 1 to 5C, the battery cell 100a illustrated in FIGS. 6 to 7C differs from that of FIGS. 1 to 5C in that the battery cell 100a has a configuration in which the cap plate 150 and the cell case 110 are coupled to each other by welding. The description of FIGS. 1 to 5c may be applied to FIGS. 6 to 7c except for the differences, and the description will focus on the differences.

As illustrated in FIGS. 6 to 7C, the battery cell 100a may include an electrode assembly 120, a cell case 110 in which an accommodation space for accommodating the electrode assembly 120 is formed and one side thereof is open, a cap plate 150 covering an open portion of the cell case 110 and coupled to the cell case 110, and a magnetic member 170 providing magnetic force to the cap plate 150 so that the cap plate 150 may maintain an aligned position with respect to the cell case 110. The magnetic member 170 may be disposed on (in) at least one of the electrode assembly 120, the cell case 110 or the cap plate 150.

The battery cell 100a may further include at least some of the electrode terminal 140, the first current collector 131, the second current collector 132, the first gasket 161 or the insulating member 163. Since the cell case 110 and the cap plate 150 are coupled to each other by welding, a gasket (for example, the second gasket 162 of FIG. 2) may not be disposed between the cell case 110 and the cap plate 150. In an embodiment of FIG. 6, the electrode assembly 120 may not include the core 125 (see FIG. 2).

The battery cell 100a may further include a bottom plate 165 disposed between the electrode assembly 120 and the cap plate 150.

The cell case 110 may include an upper plate 112 covering the upper portion of the electrode assembly 120 and a tube 111 covering the side surface of the electrode assembly 120.

Referring to FIG. 7A, the electrode assembly 120 may be disposed in the accommodation space of the cell case 110. In FIG. 7A, the magnetic member 170 may be disposed in the lower end 111a of the tube 111, and the end 111a of the tube 111 may have a shape extending in the first direction (Z-direction). The magnetic member 170 may be attached to an outer surface of the tube 111.

Referring to FIG. 7B, the tube 111 may include a bent portion 111d formed by bending the lower end 111a of the tube 111 toward the inside of the cell case 110. After the electrode assembly 120 is disposed in the accommodation space of the cell case 110, the lower end 111a of the tube 111 may be bent toward the inside of the cell case 110 to form a bent portion 111d. The bent portion 111d may have a shape bent by approximately 90 degrees.

The magnetic member 170 may include a first member 171 disposed on the bent portion 111d so as to face the inner surface of the cap plate 150. The first member 171 may be disposed to face the outside of the cell case 110 and may face the inner surface of the cap plate 150. When the first member 171 is disposed on the tube 111 of the cell case 110, the cap plate 150 may include a metal material that is couplable to a magnetic body.

The first member 171 may be comprised of a plurality of members disposed on the bent portion 111d of the tube 111. That is, a plurality of first members 171 may be disposed on the circumferential direction of the bent portion 111d of the tube 111. The plurality of first members 171 may be spaced apart from each other by a constant interval in the circumferential direction of the tube 111.

Referring to FIG. 7C, the open portion of the cell case 110 may be covered by the cap plate 150. The cap plate 150 may be disposed on the bent portion 111d. When the cap plate 150 is disposed on the bent portion 111d, the first member 171 of the magnetic member 170 may provide magnetic force to the cap plate 150. The cap plate 150 may maintain the aligned position with respect to the cell case 110 by the magnetic member 170. Accordingly, even when the cell case 110 moves or vibrations occur in the cell case 110 for the purpose of proceeding with the manufacturing process, the magnetic member 170 may maintain the cap plate 150 and the cell case 110 in an aligned state.

In order to fix the cap plate 150 to the tube 111 of the cell case 110, the cap plate 150 and the cell case 110 may be welded to each other. The tube 111 may further include a weld portion 111e formed by welding the lower end 111a of the tube 111 and the cap plate 150. The weld portion 111e may be used to couple and seal a space between the cap plate 150 and the cell case 110. In FIG. 7C, the weld portion 111e is illustrated as being formed on a side surface of the case, but the weld portion 111e may also be formed by being welded in a direction oriented from the cap plate 150 toward the bent portion 111d.

FIGS. 8A to 8C are cross-sectional views sequentially illustrating a manufacturing process of a battery cell 100a according to another embodiment.

As compared to FIGS. 7A to 7C, the embodiments illustrated in FIGS. 8A to 8C differ from those of FIGS. 7A to 7C only in an arrangement structure of the magnetic member 170. The description of FIGS. 6 to 7c may also be applied to FIGS. 8A to 8C except for the difference.

Referring to FIGS. 8A to 8C, the magnetic member 170 may further include a second member 172 disposed on the cap plate 150 at a position corresponding to the first member 171. That is, the magnetic member 170 may include the first member 171 and the second member 172.

The first member 171 may be disposed on the bent portion 111d of the case so as to face the cap plate 150, and the second member 172 may be disposed on a portion of the cap plate 150 facing the bent portion 111d. The second member 172 may be attached to the cap plate 150. A groove may for installing the second member 172 be formed in the cap plate 150, and the second member 172 may be attached in a state of being fitted into the groove of the cap plate 150. The second member 172 may be disposed on the inner surface of the cap plate 150 facing the electrode assembly 120, but the present disclosure is not limited thereto.

At least one of the first member 171 or the second member 172 may include a magnetic material.

When both the first member 171 and the second member 172 include the magnetic material, the first member 171 and the second member 172 may be disposed so that different polarities (N pole or S pole) thereof face each other so that attractive force acts therebetween. Alternatively, one of the first member 171 and the second member 172 may include the magnetic material, and the other thereof may include a metal material that is couplable to the magnetic material by the magnetic force of the magnetic material.

When the cap plate 150 is formed of a metal material that does not react to or is not sensitive to magnetic force, the cap plate 150 may be aligned with respect to the cell case 110 by the magnetic force between the first member 171 and the second member 172.

Referring to FIG. 8A, the electrode assembly 120 may be disposed in the accommodation space of the cell case 110. In FIG. 8A, the magnetic member 170 may be disposed on the lower end 111a of the tube 111.

Referring to FIG. 8B, After the electrode assembly 120 is disposed in the accommodation space of the cell case 110, the lower end 111a of the tube 111 may be bent toward the inside of the cell case 110 to form a bent portion 111d. The first member 171 of the magnetic member 170 may be disposed on the bent portion 111d so as to face the inner surface of the cap plate 150. The second member 172 of the magnetic member 170 may be disposed on the cap plate 150 so as to face the first member 171.

Referring to FIG. 8C, the open portion of the cell case 110 may be covered by the cap plate 150. When the cap plate 150 is disposed on the bent portion 111d, the cap plate 150 may maintain the aligned position with respect to the cell case 110 by the first member 171 and the second member 172. In order to fix the cap plate 150 to the tube 111 of the cell case 110, the cap plate 150 and the cell case 110 may be welded to each other.

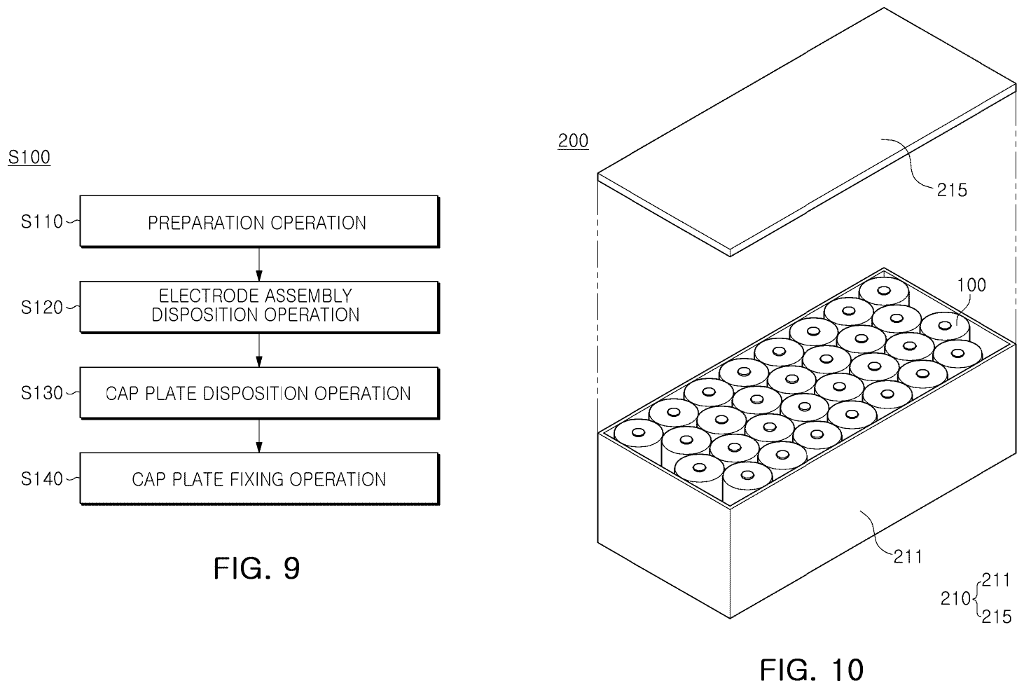

FIG. 9 is a flow chart illustrating a method (S100) of manufacturing a battery cell according to an embodiment.

Referring to FIG. 9 together with FIGS. 1 to 8C, a method (S100) of manufacturing a battery cell according to an embodiment will be described.

A method (S100) of manufacturing a battery cell according to an embodiment may include a preparation operation (S110), an electrode assembly disposition operation (S120), a cap plate disposition operation (S130), and a cap plate fixing operation (S140).

The preparation operation (S110) may prepare various components for assembling battery cells 100 and 100a. For example, the preparation operation (S110) may prepare an electrode assembly 120, a cell case 110 in which an accommodation space for accommodating the electrode assembly 120 is formed and one side thereof is open, a cap plate 150 covering an open portion of the cell case 110, and a magnetic member 170 providing magnetic force to the cap plate 150.

The cell case 110 may include an upper plate 112 covering an upper portion of the electrode assembly 120 and a tube 111 covering a side surface of the electrode assembly 120. The upper plate 112 and the tube 111 of the cell case 110 may be formed integrally. The cell case 110 may have a shape in which a bottom side is open. The cap plate 150 may cover the open bottom portion of the cell case 110.

The magnetic member 170 may be disposed on (in) at least one of the electrode assembly 120, the cell case 110 or the cap plate 150.

For example, the magnetic member 170 may be disposed in the core 125 of the electrode assembly 120 as in the embodiments illustrated in FIGS. 3A to 3C. The magnetic member 170 may include a first member 171 disposed on the core 125 of the electrode assembly 120 and a second member 172 disposed on the cap plate 150, as in the embodiments illustrated in FIGS. 4A to 4C. The magnetic member 170 may be disposed on the lower end 111a of the tube 111, as in the embodiments illustrated in FIGS. 5A to 5C. The magnetic member 170 may be disposed on the bent portion 111d formed on the lower end 111a of the tube 111, as in the embodiments illustrated in FIGS. 7A to 7C. The magnetic member 170 may include a first member 171 disposed on the bent portion 111d of the tube 111 and the second member 172 disposed on the cap plate 150, as in the embodiments illustrated in FIGS. 8A to 8C.

The preparation operation (S110) may further prepare at least some of the electrode terminal 140, the first current collector 131, the second current collector 132, the first gasket 161, the second gasket 162 or the insulating member 163.

The preparation operation (S110) may include a process of riveting the electrode terminal 140 to the through-hole 113 formed in the upper plate 112 of the cell case 110. The electrode terminal 140 may be riveted to the upper plate 112 together with the first gasket 161. That is, the preparation operation (S110) may include a process of preparing the cell case 110 to which an electrode terminal 140 is coupled.

The preparation operation (S110) may include a process of connecting a first current collector 131 to a first electrode tab 122 of an electrode assembly 120, and a process of connecting a second current collector 132 to a second electrode tab 123 of an electrode assembly 120. As an example, the first current collector 131 and the first electrode tab 122 may be coupled by welding, and the second current collector 132 and the second electrode tab 123 may be coupled by welding. That is, the preparation operation (S110) may include a process of preparing the electrode assembly 120 to which the first current collector 131 and the second current collector 132 are connected. However, the second current collector 132 may not be disposed, or may be connected to the second electrode tab 123 after the electrode assembly 120 is disposed within the cell case 110.

The electrode assembly disposition operation (S120) may dispose the electrode assembly 120 in the accommodation space of the cell case 110.

The electrode assembly 120 may be disposed inside the cell case 110 in a state in which the first electrode tab 122 is oriented toward the electrode terminal 140. The first current collector 131 connected to the outside of the first electrode tab 122 may be in contact with the electrode terminal 140. The first current collector 131 and the electrode terminal 140 may be electrically connected by welding or the like. The insulating member 163 may be disposed between the first collector 131 and the upper plate 112 for insulation.

In the cap plate disposition operation (S130), the open portion of the cell case 110 may be covered by the upper plate 112. The cap plate 150 may be disposed at the lower end 111a of the cell case 110 to cover the accommodation space.

The cap plate disposition operation (S130) may allow the cap plate 150 to maintain an aligned position with respect to the cell case 110 through the magnetic member 170. The magnetic member 170 may be disposed on at least one of the electrode assembly 120, the cell case 110 or the cap plate 150.

In the cap plate fixing operation (S140), the cell case 110 and the cap plate 150 may be coupled to each other. The cap plate 150 may be coupled to the tube 111 of the cell case 110 by crimping, welding, or the like. The cap plate fixing operation (S140) may be performed in a state in which the cap plate 150 maintains the aligned position.

Hereinafter, various embodiments of the cap plate disposition operation (S130) and the cap plate fixing operation (S140) will be described with reference to FIGS. 3A to 5C and FIGS. 7A to 8C.

First, the cap plate disposition operation (S130) and the cap plate fixing operation (S140) will be described in the embodiments illustrated in FIGS. 3A to 5C.

In the case of the embodiments illustrated in FIGS. 3A to 3C, the cap plate disposition operation (S130) may be configured to maintain the cap plate 150 in the aligned position with respect to the cell case 110 through the magnetic member 170 disposed on the core 125 of the electrode assembly 120.

In the case of the embodiments illustrated in FIGS. 4A to 4C, the magnetic member 170 may include a first member 171 disposed on the core 125 of the electrode assembly 120 and a second member 172 disposed on the cap plate 150. The cap plate disposition operation (S130) may be configured to maintain the cap plate 150 in the aligned position with respect to the cell case 110 through the magnetic member 170 disposed on the core 125 of the electrode assembly 120 and the cap plate 150.

In the case of the embodiments illustrated in FIGS. 5A to 5C, the cap plate disposition operation (S130) may be configured to maintain the cap plate 150 in the aligned position with respect to the cell case 110 through the magnetic member 170 disposed on the lower end 111a of the tube 111.

The cap plate disposition operation (S130) may include a process of forming a beading portion 111b recessed toward the center of the cell case 110 in the lower end 111a of the tube 111 as illustrated in FIGS. 3A, 4A and 5A, and a process of disposing the cap plate 150 above the beading portion 111b as illustrated in FIGS. 3B, 4B, and 5B. The cap plate 150 may be disposed on the beading portion 111b in a state in which the second gasket 162 is disposed on a circumferential surface thereof.

The cap plate fixing operation (S140) may include a process of forming a crimping portion 111c covering the cap plate 150 with the lower end 111a of the tube 111, as illustrated in FIGS. 3C, 4C and 5C. The second gasket 162 may seal a space between the crimping portion 111c of the tube 111 and the cap plate 150.

Next, the cap plate disposition operation (S130) and the cap plate fixing operation (S140) in the embodiments shown in FIGS. 7A to 8C will be described.

In the embodiment illustrated in FIGS. 7A to 8C, the cap plate disposition operation (S130) may include a process of forming a bent portion 111d bent toward the inside of the cell case 110 in the lower end 111a of the tube 111 as illustrated in FIGS. 7B and 8B, and a process of maintaining the cap plate 150 in the aligned position with respect to the cell case 110 through the magnetic member 170 disposed on the bent portion 111d so as to face the inner surface of the cap plate 150 as illustrated in FIGS. 7C and 8C.

In the embodiments of FIGS. 8A to 8C, the magnetic member 170 may include a first member 171 disposed in the bend portion 111d of the tube 111 and a second member 172 arranged in the cap plate 150. The cap plate disposition operation (S130) may be configured to maintain the cap plate 150 in the aligned position with respect to the cell case 110 through the magnetic member 170 disposed in the bend portion 111d of the cell case 110 and the cap plate 150.

The cap plate fixing operation (S140) may include a process of welding the cap plate 150 to the lower end 111a of the tube 111, as illustrated in FIGS. 7C and 8C. Through the cap plate fixing operation (S140), a weld portion 111e may be formed between the cell case 110 and the cap plate 150.

FIG. 10 is a perspective view of a battery module according to an embodiment.

Referring to FIG. 10, a battery module 200 according to an embodiment may include a plurality of battery cells 100 and a module housing 210 accommodating the plurality of battery cells 100.

The battery cell 100 provided in the battery module 200 may be applied to at least one of the battery cell 100 described with reference to FIGS. 1 to 5C or the battery cell 100a described with reference to FIGS. 6 to 8C.

When the battery module 200 of the present disclosure includes a plurality of battery cells 100, a specific type or shape thereof is not limited. For example, the battery module 200 of the present disclosure may be defined as at least one of a battery module, a battery pack, an energy storage device, a vehicle.

The module housing 210 may provide a space for accommodating a plurality of battery cells 100. The module housing 210 may include a housing body 211 forming a space for accommodating a plurality of battery cells 100, and a housing cover 215 covering an upper side of the plurality of battery cells 100.

The above-described contents are merely examples of applying the principles of the present disclosure, and other components may be further included without departing from the scope of the present disclosure. In addition, some components may be deleted from the above-described embodiments, and each embodiment may be implemented in combination with each other.

What is claimed is:

1. A battery cell, comprising:
an electrode assembly;
a cell case in which an accommodation space for accommodating the electrode assembly is formed and one side thereof is open and;
a cap plate covering an open portion of the cell case and coupled to the cell case; and
a magnetic member providing magnetic force to the cap plate so that the cap plate maintains an aligned position with respect to the cell case,
wherein the magnetic member is disposed on at least one of the electrode assembly, the cell case or the cap plate.

2. The battery cell of claim 1, wherein the electrode assembly includes a body in which electrodes and separators are arranged to form layers, a first electrode tab disposed on a first side of the body and having a first polarity, a second electrode tab disposed on a second side of the body and having a second polarity, and a core disposed in a center of the body, and
the magnetic member includes a first member disposed on the core so as to provide magnetic force to the cap plate.

3. The battery cell of claim 2, wherein the magnetic member further includes a second member disposed on the cap plate at a position corresponding to the first member, and
at least one of the first member or the second member includes a magnetic body.

4. The battery cell of claim 1, wherein the cell case includes an upper plate covering an upper portion of the electrode assembly, and a tube covering a side surface of the electrode assembly, and
the magnetic member includes a first member disposed on a lower end of the tube so as to face a circumferential surface of the cap plate.

5. The battery cell of claim 4, wherein the tube has a shape extending in a first direction,
the tube includes a beading portion recessed in a second direction toward a center of the cell case, and
the first member is disposed further outward in the first direction than the beading portion.

6. The battery cell of claim 4, wherein the first member is comprised of a plurality of members disposed on the lower end of the tube.

7. The battery cell of claim 1, wherein the cell case includes an upper plate covering an upper portion of the electrode assembly and a tube covering the side surface of the electrode assembly,
wherein the tube includes a beading portion recessed toward a center of the cell case, and a crimping portion covering the cap plate with a lower end of the tube.

8. The battery cell of claim 1, wherein the cell case includes an upper plate covering an upper portion of the electrode assembly and a tube covering a side surface of the electrode assembly,
the tube includes a bent portion formed by bending a lower end of the tube toward an inside of the cell case, and
the magnetic member includes a first member disposed on the bent portion so as to face an inner surface of the cap plate.

9. The battery cell of claim 8, wherein the magnetic member further includes a second member disposed on the cap plate at a position corresponding to the first member, and
at least one of the first member or the second member includes a magnetic body.

10. The battery cell of claim 8, wherein the tube further includes a weld portion formed by welding the lower end of the tube and the cap plate.

11. The battery cell of claim 1, wherein the cell case includes an upper plate covering an upper portion of the electrode assembly, and a tube covering a side surface of the electrode assembly,
the tube includes a circular cross-section, and
the upper plate and the tube are formed integrally.

12. The battery cell of claim 11, further comprising:
an electrode terminal installed on the upper plate and electrically connected to a first electrode tab of the electrode assembly,
wherein the electrode terminal is coupled to a through-hole of the upper plate and has a rivet shape.

13. A method of manufacturing a battery cell, the method comprising:
a preparation operation of preparing an electrode assembly, a cell case in which an accommodation space for accommodating the electrode assembly is formed and one side thereof is open, a cap plate covering an open portion of the cell case, and a magnetic member providing magnetic force to the cap plate;
an electrode assembly disposition operation of disposing the electrode assembly in the accommodation space of the cell case;
a cap plate disposition operation of covering the open portion of the cell case with the cap plate; and
a cap plate fixing operation of coupling the cell case and the cap plate,
wherein the magnetic member is disposed on at least one of the electrode assembly, the cell case or the cap plate,
in the cap plate disposition operation, the cap plate maintains an aligned position with respect to the cell case through the magnetic member, and
the cap plate fixing operation is performed in a state in which the cap plate maintains the aligned position.

14. The method of manufacturing a battery cell of claim 13, wherein in the cap plate disposition operation, the cap plate maintains the aligned position with respect to the cell case through the magnetic member disposed on a core of the electrode assembly.

15. The method of manufacturing a battery cell of claim 13, wherein the cell case includes an upper plate covering an upper portion of the electrode assembly and a tube covering a side surface of the electrode assembly, and
in the cap plate disposition operation, the cap plate maintains the aligned position with respect to the cell case through the magnetic member disposed in a lower end of the tube.

16. The method of manufacturing a battery cell of claim 13, wherein the cell case includes an upper plate covering an upper portion of the electrode assembly and a tube covering a side surface of the electrode assembly, and
the cap plate disposition operation includes a process of forming a beading portion recessed toward a center of the cell case in a lower end of the tube, and a process of disposing the cap plate above the beading portion.

17. The method of manufacturing a battery cell of claim 16, wherein the cap plate fixing operation includes a process of forming a crimping portion covering the cap plate with the lower end of the tube.

18. The method of manufacturing a battery cell of claim 13, wherein the cell case includes an upper plate covering an upper portion of the electrode assembly and a tube covering a side surface of the electrode assembly, and
the cap plate disposing operation includes a process of forming a bent portion bent toward an inside of the cell case in a lower end of the tube, and a process in which the cap plate maintains the aligned position with respect to the cell case through the magnetic member disposed in the bent portion so as to face an inner surface of the cap plate.

19. The method of manufacturing a battery cell of claim 18, wherein the cap plate fixing operation includes a process of welding the cap plate to the lower end of the tube.

20. A battery module comprising:
a plurality of battery cells; and
a module housing accommodating the plurality of battery cells,
wherein at least one of the plurality of battery cells includes:
an electrode assembly;
a cell case in which an accommodation space for accommodating the electrode assembly is formed and one side thereof is open;
a cap plate covering an open portion of the cell case and coupled to the cell case; and
a magnetic member providing magnetic force to the cap plate so that the cap plate maintains an aligned position,
wherein the magnetic member is disposed on at least one of the electrode assembly, the cell case or the cap plate.
